(19) United States
(12) Patent Application Publication
(10) Pub. No.: US 2005/0265245 A1
(43) Pub. Date: Dec. 1, 2005

(54) Method of transferring data in a local household network

(75) Inventors: Theo Buchner, Neustadt (DE); Bernhard Kobl, Sandersdorf (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 11/157,028

(22) Filed: Jun. 20, 2005

Related U.S. Application Data
(63) Continuation of application No. PCT/EP03/14095, filed on Dec. 11, 2003.

(30) Foreign Application Priority Data
Dec. 20, 2002 (DE) 10260143.7

(51) Int. Cl. H04L 12/26

(52) U.S. Cl. 370/241; 370/401

(57) ABSTRACT

A method transfers data in a local household network. The local household network has at least one network-capable domestic appliance and at least one gateway to at least one other network. The network-capable domestic appliance can be integrated in a local household network and the local household network contains at least one gateway to at least one other network. The domestic appliance includes a testing device configured such that a preset criterion of the domestic appliance can be tested with the testing device. The data can then be transferred from the domestic appliance to the gateway when the preset criterion is satisfied.

### CROSS-REFERENCE TO RELATED APPLICATION

This is a continuing application, under 35 U.S.C. § 120, of copending international application No. PCT/EP2003/014095, filed Dec. 11, 2003, which designated the United States; this application also claims the priority, under 35 U.S.C. § 119, of German patent application No. 102 60 143.7, filed Dec. 20, 2002; the prior applications are herewith incorporated by reference in their entirety.

### BACKGROUND OF THE INVENTION

### FIELD OF THE INVENTION

The invention relates to a method for transferring data in a local household network, whereby the local household network includes at least one network-capable domestic appliance and at least one gateway to at least one other network. In addition to this the invention relates to a network-capable domestic appliance, which can be integrated in a local household network, whereby the local household network contains at least one gateway to at least one other network.

Domestic appliances can include, for example: a heating appliance, a room-monitoring unit, a refrigerator, a washing machine or a stove. In the field of control of domestic appliances it is known, using the European Home Systems Standard (EHS Standard), to configure the respective domestic appliances to be controlled such that they can be controlled from a central instance according to the EHS communications protocol, i.e. the algorithmic sequence of data transfers between the central instance and the domestic appliances is established through the EHS communications protocol.

In this context it is known that all services required or desired for control, for example applications such as an Internet browser, an electronic mail system or similar, are implemented direct as a service of the application layer in the domestic appliance itself.

A washing machine with an Internet connection is known from the reference titled “Talking Washing Machine with Internet Connection” (http://www.golem.de/9912/5441.html). This washing machine includes a multifunction module with an http server and interface cards.

Such technology substantially adds cost to a domestic appliance, such as e.g. a washing machine. This is particularly unfavorable when several domestic appliances are connected to an external network, such as the Internet, as in this case each individual one of these domestic appliances must be equipped with corresponding efficient and thus expensive hardware.

A more beneficial option for linking up several domestic appliances to an external network, such as the Internet, is to use a central communications interface, a so-called gateway, between a local household network and the external network. The individual domestic appliances are connected via the local household network to the gateway and the gateway to the external network, i.e. the plurality of communications connections of the individual domestic appliances to the external network is reduced to the gateway.

To realize data exchanges between an external user and the domestic appliances in the most friction-free manner possible, data of the domestic appliances are held ready in the gateway, so that faster access by an external user via the external network is guaranteed. The data of the domestic appliances are constantly updated by the gateway, in that the gateway calls up the data from the domestic appliances cyclically at very brief intervals over the local household network.

Because any number of domestic appliances can be linked to the local household network this results in high data traffic in the local household network. The data transfer quality in particular in local household networks, such as e.g. radio networks or supply voltage networks, and thus also the stability of these systems is reduced.

### SUMMARY OF THE INVENTION

It is accordingly an object of the invention to provide a method for transferring data in a local household network which overcomes the above-mentioned disadvantages of the prior art methods of this general type, in which the system stability of local household networks is improved.

With the foregoing and other objects in view there is provided, in accordance with the invention, a method for transferring data in a local household network. The local household network contains at least one network-capable domestic appliance and at least one gateway to at least one other network. The method includes checking a presettable criterion of the domestic appliance using a testing device of the domestic appliance so that a cyclic query by the gateway is prevented. The presettable criterion are a change of state and/or value change of the domestic appliance. The data is then transferred from the domestic appliance to the gateway if the presettable criterion is satisfied.

The task is solved by a method of the type initially described, by the fact that the domestic appliance contains a testing device, in which a presettable criterion of the domestic appliance is checked, and the data are transferred from the domestic appliance to the gateway when the presettable criterion is satisfied. In addition to this, the task is solved by a domestic appliance of the type initially described by the fact that the domestic appliance contains a testing device, configured such that a presettable criterion of the domestic appliance can be checked using the testing device, and the data can then be transferred from the domestic appliance to the gateway when the presettable criterion is satisfied.

It is an advantage to check in the domestic appliance whether the presettable criterion, such as for example a change of state and/or change of value of the domestic appliance, is satisfied, at which point it is ensured that system stability is improved, since cyclic query by the gateway is prevented, and the data traffic in the household network is clearly reduced. This is advantageous in particular when the domestic appliance changes its state and/or its values only infrequently, such as for example a refrigerator changing its actual temperature or a washing machine changing its or respectively a dishwashing machine changing its program phases.

If the presettable criterion in particular includes an error alert of the domestic appliance, this is particularly advantageous since the data traffic is reduced to the important cases of error functions of the domestic appliance.

According to a favorable variant of the invention the local household network is a supply voltage network.

In this case the invention is particularly advantageous, because in supply voltage networks, such as for example power lines, the data traffic can be easily interfered with e.g. by insufficiently suppressed devices. Therefore the effect of the inventive reduction of data traffic in supply voltage networks particularly is system stabilizing.

The testing device is preferably a microcontroller.

The use of a microcontroller, in particular the microcontroller of the domestic appliance, is particularly advantageous as a testing device, since in this way testing the presettable criterion can be carried out cost-effectively by a software program.

In a further development the other network is a wireless network.

A mobile monitoring station, e.g. a webpad, can be connected to the gateway via the wireless network, such as for example a local radio network, so that the domestic appliances of the local household network can accordingly both be monitored by the mobile monitoring station, as well as controlled. In a wireless network the receiver range can however also contain appliances from neighboring households, resulting in data traffic being interfered with. The effect of the inventive reduction in data traffic in wireless networks is particularly system-stabilizing.

Other features which are considered as characteristic for the invention are set forth in the appended claims.

Although the invention is illustrated and described herein as embodied in a method of transferring data in a local household network, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a system for transferring data in a local household network; and

FIG. 2 is a flow chart of a method for transferring data in the local household network.

### DESCRIPTION OF THE PREFERRED EMBODIMENTS

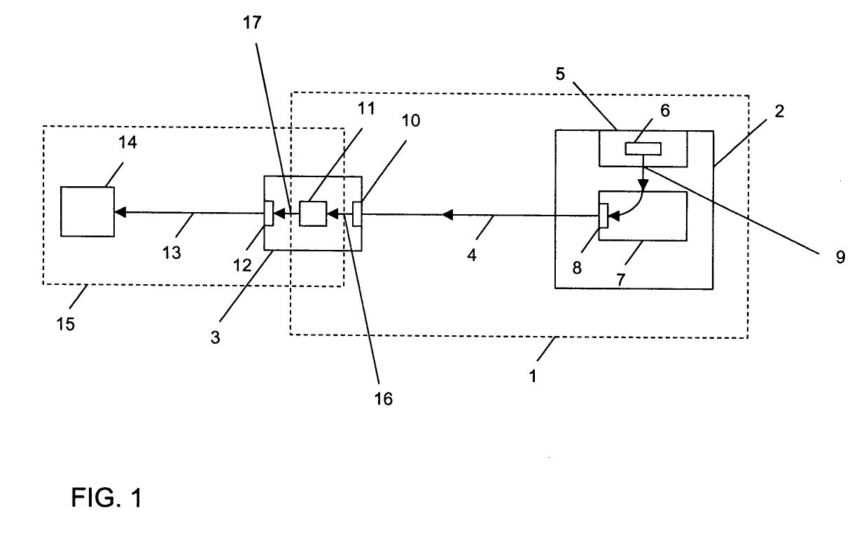

Referring now to the figures of the drawing in detail and first, particularly, to FIG. 1 thereof, there is shown a local household network 1 which contains a network-capable domestic appliance 2, a gateway 3 and a local data transfer line 4 between the domestic appliance 2 and the gateway 3. The domestic appliance 2, which can be e.g. a refrigerator, a washing machine, a dishwasher, a stove or a range hood, contains a controller 5 with a microcontroller 6, a communications module 7 with an interface 8 for data transfer line 4 and a connecting line 9 between the controller 5 and the communications module 7. The gateway 3 contains an interface 10 for the local data transfer line 4, a data storage 11 and an interface 12 to an external transfer path 13 between the gateway 3 and a user 14 of an external network 15, such as e.g. an open network, such as the Internet, or a wireless network, as well as a connection 16 between the interface 10 for the data transfer line 4 and the data storage 11 and a connection 17 between the data storage 11 and the interface 12 to the external data transfer path 13.

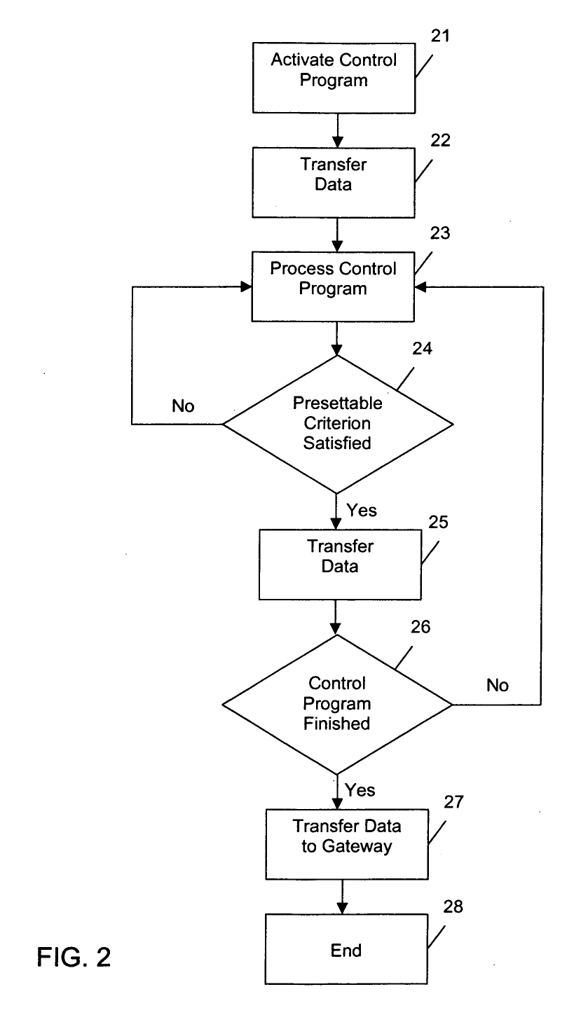

The domestic appliance 2 is regulated via the controller 5 and here in particular by a control program of the microcontroller 6. The microcontroller 6 also functions as a testing device in which a presettable criterion of the domestic appliance 2 can be checked, as described in detail in FIG. 2. If this criterion is satisfied data are then transferred from the microcontroller 6 via the connection line 9 to the communications module 7. From the communications module 7 the data are transferred by way of the interface 8 via the data transfer line 4 to the interface 10 of the gateway 3 and stored there via the connection 16 in the data storage 11. A change of format of the data optionally carried out in the gateway 3 prior to storage is not shown here. The user 14, which can be e.g. a central control station such as a webpad or an external server, can now access the data in the data storage 11 via the external transfer path 13, the interface 12 of the gateway 3 and the connection 17.

In general the connection lines 9, 16, 17 and the data transfer line 4 or the data transfer path 13 can also be wireless.

If the domestic appliance 2 is switched on, in a first procedural step 21 according to FIG. 2 a control program in the microcontroller 6 is activated and status variables are initialized. In a second procedural step 22, as described via FIG. 1, data are transferred via activating the domestic appliance 2 to the gateway 3 and stored there in the data storage 11. In a third procedural step 23 the next step of the control program is processed. In a next procedural step 24 a check is made as to whether the presettable criterion, which can be e.g. a change in status variables or an error alert, is satisfied. If this is not the case, procedural step 23 is continued. If the criterion is satisfied then in the next procedural step 25 data, which include for example the value of the status variables or the error alert, as described in FIG. 1, are transferred to the gateway 3 and stored there in the data storage 11. The data optionally already available in the data storage 11 via the domestic appliance 2 are updated in this way. In the next procedural step 26 a check is made as to whether the control program is finished. Should this not be the case procedural step 23 is continued. If the control program is finished in a next procedural step 27 data are transferred via the ending of the control program, as described in FIG. 1, to the gateway 3 and stored there in the data storage 11. In a final procedural step 28 the domestic appliance 2 is then switched off or placed in standby mode.

The method sketched in FIG. 2 can be carried out by the microcontroller 6 using a software program. An alternative option is a circuit-based reversal, such as e.g. in a flip-flop circuit. In addition to this also parallel processing of various procedural steps is possible apart from the serial processing of the individual procedural steps 21 to 28 illustrated in FIG. 2.

1. A method for transferring data in a local household network, the local household network contains at least one network-capable domestic appliance and at least one gateway to at least one other network, which comprises the steps of:
checking a presettable criterion of the domestic appliance using a testing device of the domestic appliance, the presettable criterion being a change of state and/or value change of the domestic appliance, so that a cyclic query by the gateway is prevented; and
transferring the data from the domestic appliance to the gateway if the presettable criterion is satisfied.

2. The method according to claim 1, which further comprises forming the presettable criterion to include an error alert of the domestic appliance.

3. The method according to claim 1, wherein the local household network is a supply voltage network.

4. The method according to claim 1, which further comprises using a microcontroller as the testing device.

5. The method according to claim 1, which further comprises setting up the other network as a wireless network.
